(19) United States
(12) Patent Application Publication
(10) Pub. No.: US 2017/0294098 A1
(43) Pub. Date: Oct. 12, 2017

(54) Life Guard Buddie

(71) Applicant: Luke Randolph Selgrist, SR., Seneca, MT (US)

(72) Inventor: Luke Randolph Selgrist, SR., Seneca, MT (US)

(21) Appl. No.: 15/482,909

(22) Filed: Apr. 10, 2017

Related U.S. Application Data
(60) Provisional application No. 62/320,566, filed on Apr. 10, 2016.

(51) Int. Cl. G08B 21/08; G08B 25/10; G08B 21/02; G08B 25/01

(52) U.S. Cl. CPC G08B 21/088; G08B 25/016; G08B 25/10; G08B 21/0269; G08B 21/0283

(57) ABSTRACT

A combination of an oxygen sensor with an alarm that will sound when water is detected in the airways or lungs of a person swimming. The alarm can be heard up to 100 yards away from the location of the victim, and a GPS system linked to a phone app will help to pinpoint the location of the victim for rescuers. It can be attached to a person's body or worn like a necklace.

### CROSS-REFERENCES TO RELATED APPLICATIONS (IF ANY)

This application is the non-provisional application claiming the priority date of provisional application 62/320,566 filed Apr. 10, 2016 which is incorporated by reference.

### BACKGROUND OF THE INVENTION

### 1. Field of the Invention

The present invention relates generally to the field of sensors and more specifically one that detects when water is in a person's lung.

### 2. Description of the Related Art

Many people enjoy swimming and rarely think about the possibility of drowning. And yet, nine people drown in the United States every day. These statistics are quite alarming. especially for parents with young kids. For each death caused by drowning. there are 1-4 non-fatal submersion accidents serious enough for the victim to be hospitalized. Drowning is the second-leading cause of accidental injury-related death among children ages 1 to 14, and the leading case among children ages 1 to 4. Non-fatal drownings can result in brain damage that may result in long-term disabilities, including memory problems, learning disabilities, and permanent loss of basic functioning. Roughly 5,000 children, 14 and under, go to the hospital because of accidental drowning-related incidents each year. 15% die and about 20% suffer from permanent neurological disabilities. It is quite obvious that having a fence around a pool or a life-guard on duty at the beach is not adequate to prevent these kinds of incidents.

There is still room for improvement in the art.

### BRIEF SUMMARY OF THE INVENTION

The current invention is a combination of an oxygen sensor with an alarm that will sound when water is detected in the airways or lungs of a person swimming. The alarm can be heard up to 100 yards away from the location of the victim, and a GPS system linked to a phone app will help to pinpoint the location of the victim for rescuers.

### BRIEF DESCRIPTION OF THE DRAWINGS

Without restricting the full scope of this invention, the preferred form of this invention is illustrated in the following drawings:

FIG. 1 shows the alarm and transmitter;

FIG. 2 shows the transmitter communicating with a phone application; and

FIG. 3 shows the sensor and transmitter placed on a child.

The various embodiments of the present invention will hereinafter be described in conjunction with the appended drawings.

### DETAILED DESCRIPTION

There are a number of significant design features and improvements incorporated within the invention.

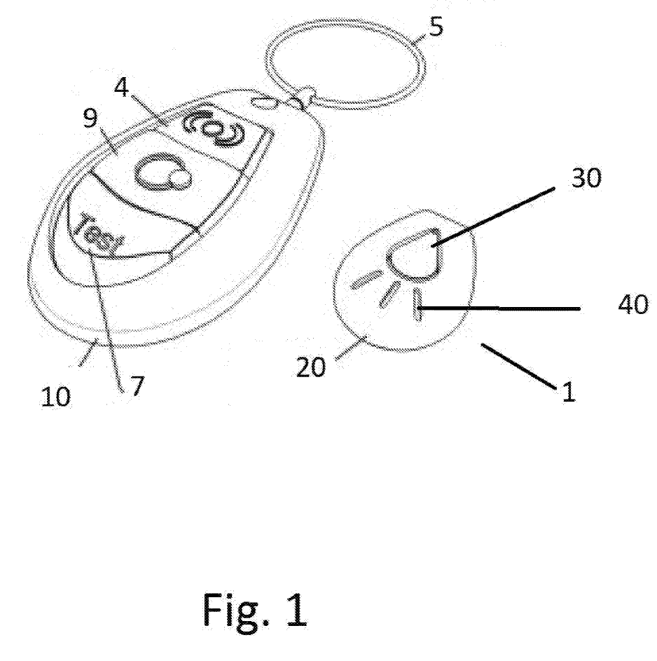

As shown in FIGS. 1 through 3, the current invention is a combination of an oxygen sensor 20 with an alarm 40 that will sound when water is detected in the airways or lungs of a person swimming. The alarm 40 will be designed so that it can be heard up to 100 yards away from the location of the victim 100, and a GPS system 9 linked to a phone application (app) 200 will help to pinpoint the location of the victim 100 for rescuers. The oxygen sensor 20 will detect water intrusion in a person's airways and lungs, and sound a loud alarm to alert life-guards or responsible adults nearby.

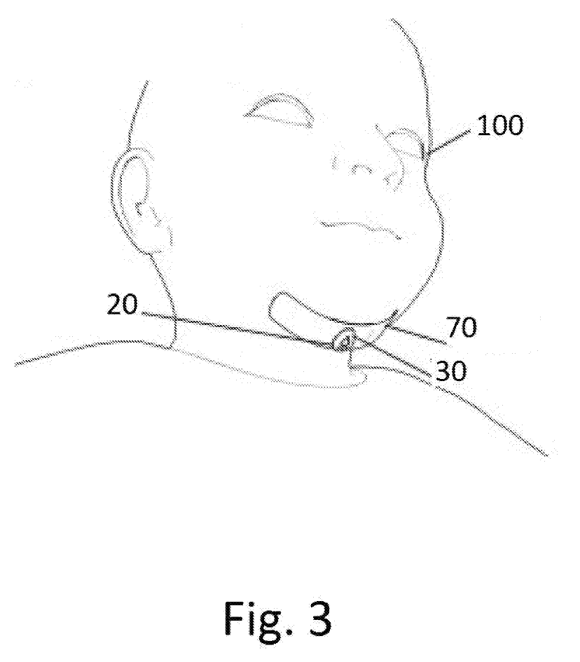

The sensor device 1 will have an oxygen sensor 20, as shown in FIGS. 1 and 3, that will detect any internal intrusion of water and activate an alarm 40 long before a life guard or companion may realize a person in the water is experiencing difficulties. The sensor 20 will also have a transmitter 20 to transmit a signal from the sensor device 1 to the remote alarm device 10 that the victim 100 is having trouble. The sensor 20 is a small device 2 can be attached to a baby, a young child or a senior with an adhesive strip or bandage 70. It would be most effective when worn under the chin of the individual as shown in FIG. 3. The sensor 20 will also have a GPS system as part of the transmitter 30.

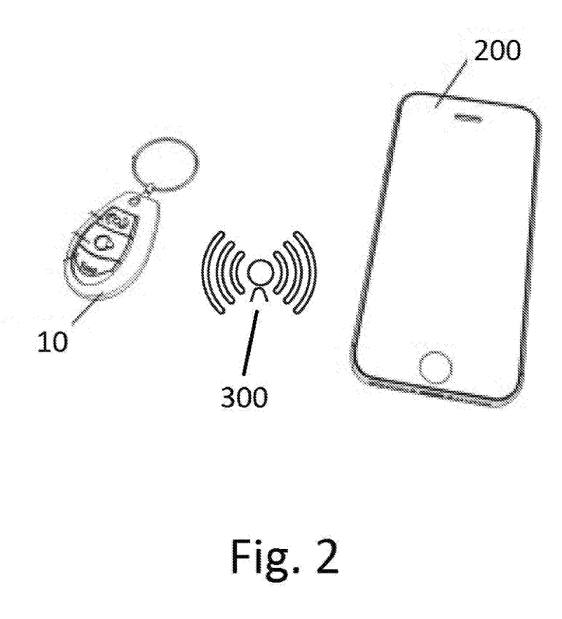

Older children and adults may nave the alarm remote device 10 on a key chain attached to some part of their swimsuits or bodies using a key ring 5. The alarm remote device 10 would be in a key fob shape in the preferred embodiment as shown in FIG. 1. The fob alarm remote device 10 would have a panic button 4 to sound the alarm manually whenever a person feels like they may be in trouble. A second button 9 can be pushed to activate the alarm on a phone linked via Blue-tooth 300 or any other wireless connection means as shown in FIG. 2. There is a test button 7 to test that the devices and system are working properly.

When the alarm application 200 on a linked phone is activated, there will be an audible alert, and the user will have the GPS coordinates needed to locate the potential victim 100. The key chain fob remote alarm device 10 can also be linked to other remote alarm devices 10 worn by friends or members of the same group, and when an alarm is heard, they may be able to perform the rescue without waiting for assistance from the professionals.

The adhesive strip 70 can match the skin tone of the person wearing it or be fitted to a necklace or a bracelet.

The sensor device 1 and remote alarm device 10 will each have a power source which in the preferred embodiment would be a battery.

Advantages

The current invention is a new life-saving device to prevent many deaths and injuries resulting from accidental drownings. The oxygen sensor will detect water intrusion in a person's airways and lungs, and sound a loud alarm to alert life-guards or responsible adults nearby. It is a convenient way to provide parents of small children with peace of mind when families are spending time at a beach, by a pool. along a river bank. and when a child wants to play unattended in a bathtub.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A device comprising:
A sensor device with a sensor, an alarm and transmitter where the sensor is an oxygen sensor that sets off an alarm when it detects that water is in a person lungs.

2. A device according to claim 2 further comprising:
Having the transmitter have a GPS system.

3. A device according to claim 2 further comprising:
Having an alarm device which the sensor device transmits to.

4. A device according to claim 2 further comprising:
Having the sensor device transmit the alarm to the alarm device.

5. A device according to claim 2 further comprising:
Having the sensor device transmit the alarm to the alarm device.

6. A device according to claim 4 further comprising:
Having the alarm device have a test button and an alarm button.

7. A device according to claim 4 further comprising:
Having the alarm device be in a key fob shape.

8. A device according to claim 1 further comprising:
Transmitting an alarm to a phone application.

9. A device according to claim 2 further comprising:
Having the sensor device transmit the alarm to multiple alarm devices.

10. A device according to claim 1 further comprising:
Having the sensor device attached to a person using an adhesive strip.

11. A device according to claim 10 further comprising:
Having the adhesive strip match the skin tone of the person wearing it.

12. A device comprising:
A sensor device with a sensor, an alarm and transmitter where the sensor is an oxygen sensor that sets off an alarm when it detects that water is in a person lungs, where the transmitter has a GPS system, having an alarm device which the sensor device transmits to where the sensor device transmit the alarm to the alarm device.

13. A device according to claim 12 further comprising:
Having the sensor device transmit the alarm to the alarm device.

14. A device according to claim 12 further comprising:
Having the alarm device have a test button and an alarm button.

15. A device according to claim 12 further comprising:
Having the alarm device be in a key fob shape.

16. A device according to claim 12 further comprising:
Transmitting an alarm to a phone application.

17. A device according to claim 12 further comprising:
Having the sensor device transmit the alarm to multiple alarm devices.

18. A device according to claim 12 further comprising:
Having the sensor device attached to a person using an adhesive strip.

19. A device according to claim 10 further comprising:
Having the adhesive strip match the skin tone of the person wearing it.

20. A process using the device according to claim 12.
